(19) United States
(12) Patent Application Publication
(10) Pub. No.: US 2012/0059675 A1
(43) Pub. Date: Mar. 8, 2012

(54) Method for the Utilization of Privately Placed Insurance Contracts as a Cohesive Operational Process for Structurally Efficient Investing, Reified as a Tax Deferred Fund

(75) Inventors: Michael Ricciardi, Englewood Cliffs, NJ (US); Henry Bregstein, Tenafly, NJ (US)

(73) Assignee: MARBLE HILL ADVISORS LLC, Englewood Cliffs, NJ (US)

(21) Appl. No.: 13/217,879

(22) Filed: Aug. 25, 2011

Related U.S. Application Data
(60) Provisional application No. 61/379,790, filed on Sep. 3, 2010.
(60) Provisional application No. 61/391,208, filed on Oct. 8, 2010.

(51) Int. Cl. G06Q 40/08

(52) U.S. Cl. 705/4

(57) ABSTRACT

A method performed by a computer of arranging a privately placed variable annuity, including negotiating with at least one life insurance company for a standardized annuity contract; evaluating the standardized annuity contract and a plurality of investments by a plurality of specialists; performing at least one of legal analysis, regulatory analysis, due diligence, and compliance analysis with respect to the plurality of investments; using the computer to provide efficient scalability of the product, and made concrete by embodiment as a privately placed, tax deferred fund (TDF), and the selling by at least one broker of an interest in the TDF to a qualified prospect (Investor Annuitant) who thereby gains exposure to the privately placed variable annuity based on the standardized annuity contract and the plurality of investments.

### FIELD OF THE INVENTION

The present invention relates to privately placed, variable, deferred annuity contracts and variable life insurance contracts and the selection of life insurance company providers of such products, the negotiation of annuity contracts or life insurance contracts, and the selection and creation of reference investment funds, including the administration, but not the investment management, of such reference funds, (“Insurance Dedicated Funds” or “IDF”) in a manner reified as a privately placed, tax deferred fund (“TDF™) that provides convenience, diversification of counterparty risk, and cost effective investment for investors, in part, through the aggregation of investments and the rationalization of the legal documentation and process, together with related initial and on going due diligence, while streamlining the marketing, sales and underwriting process, including the qualification of investors (i.e., contract owners), while maintaining the positive tax attributes of the insurance contracts. Certain aspects of the invention may also be utilized in conjunction with publicly registered IDFs.

### BACKGROUND OF THE INVENTION

Privately placed, variable, deferred annuity contracts are contracts entered into between life insurance companies and persons, or qualified entities which comply with the provisions of section 72 of the Internal Revenue Code of 1986, as amended (the “Code”). Under the Code, contract owners are not subject to income tax on gains during the contracts investment period (i.e., the deferral period). Under section 72 non natural persons, however, are subject to current income tax on gains related to variable contracts. After the end of the deferral period, principal and any gain are paid out to the contract owner during the annuitization period, which can be for a term of years or for the life of the contract holder. A contract owner generally may elect to terminate an annuity contract before the end of the deferral period or during the annuitization period and receive a lump-sum payment. All gains are taxed as ordinary income under the Code. An annuity contract is considered a “variable” annuity where the investment returns on contract premiums are based upon the investment gains or losses of a separate account of the insurance company issuer. The contract owner can, subject to certain Code mandated restrictions and limitations, select the investments to which the contracts returns will be linked. The gains and losses on these investments are for the account of the contract owner. The insurance company does not share in the gains or losses of the related separate account investments. An annuity contract is considered “privately placed” where the contract is not registered under federal or state securities laws. Privately placed annuity contracts may also allow contract owners to select separate account investments that are not registered under federal and state securities laws (i.e., Insurance Dedicated Funds). In order for a variable annuity or life insurance contract to qualify for tax deferral, the insurance company and not the contract owners must be considered to be the owner of the assets held in the separate account of the insurance company. Therefore, a contract owner or its agents may exercise only limited control over the investment decisions relating to the separate account. Other than the contract owner's right to allocate premiums and transfer funds among the available IDFs, all investment decisions concerning the investments must be made by the IDF investment advisors in their sole and absolute discretions. Specifically, a contract owner or prospective contract owner cannot select or recommend particular investments or investment strategies, which would include IDFs and their advisors, to an insurance company. Moreover, a contract owner cannot communicate directly or indirectly with any investment officer of the IDF advisor or its affiliates regarding the selection, quality, or rate of return of any specific investment or group of investments held in an IDF.

Insurance companies typically require significant minimum investments in order for individuals to enter into privately placed variable insurance contracts which has the effect of limiting the number of even qualified investors from accessing a highly desirable retirement, estate planning and investment product.

From the perspective of the insurance company (and related sales agents) entering into a privately placed, variable, deferred annuity contract (“PPVDAC”) (global), there are at least six material components to the process:
Identification of suitable privately placed IDFs, which is time consuming and inefficient, in part, because IDF advertising would violate federal and state securities laws and because many sales agents are employed by large broker-dealers that have affiliated investment advisors that may desire to act as IDF investment managers or advisors which substantially hinders or eliminates the ability of such sales agents from acting as agents for contract holders.
Marketing (an ongoing and often multi-year process), which is time consuming and inefficient, in part, because advertising would violate federal and state securities laws and because of the complexity of the product.
Sales (typically one-on-one time consuming meetings) during which the agent for the insurance company explains the contractual, tax and investment issues concerning PPVDAC and provides to the prospective purchasers samples of the PPVDAC agreement and the offering memoranda for the PPVDAC and each of the potential IDF investments (this documentation can easily exceed 5,000 pages).
Underwriting (including qualification of investors (i.e., prospective purchasers of PPVDACs)), a laborious process because of the individual processing of each contract owner.
Implementation (including the disclosure to, and selection by contract owner of IDFs, as well as completion and execution of lengthy subscription documentation), an inefficient process because of the individual processing of each contract.
Maintenance (including ongoing one-on-one investors contacts and contract administration).

From the perspective of the investor (i.e., prospective contract owner) entering into a PPVDAC, there are at least six material components to the process:
Selection of licensed insurance agent that is employed by an entity that is a general agent of one or more insurance companies, a difficult process in part due to the limited amount of verifiable information available upon which to make the differential determination.
Selection of insurance company annuity providers, a difficult process in part due to the advertising limitation noted above and the complexity of analyzing the terms of different PPVDACs and the financial conditions and prospects of such providers.
Diversification of, if possible, insurance company risk exposure.
Negotiation of the PPVDAC, a difficult process due to the lack of bargaining power, lack of transparency and complexity of the PPVDAC product and an expensive process due to the need to identify and hire professional legal and financial advisors, which may be almost functionally impossible or impracticable given the lack of knowledge of the investor and the limited pool of qualified advisors.
Selection of initial reference insurance dedicated investment funds, a difficult and time consuming process because of the lengthy documentation and the need to analyze various investment strategies and investment managers and request and review additional information and engage in due diligence with respect to the foregoing.
Ongoing investment review, including due diligence concerning insurance companies and IDFs, which implicates the same issues addressed immediately above. Privately placed, variable, life insurance contracts (“PPVLICs”) (global) are similar to PPVDACs as they are entered into between life insurance companies and persons, or qualified entities which comply with the provisions of section 7702 of the Code. Under the Code, contract owners are not subject to income tax on gains until cash is withdrawn from the contract up until the death of the insured under the contract. Up until the death of the insured, cash distributions representing gains are taxed as ordinary income under the Code, and at death, death benefits, including with related to investment gains, are not subject to income tax under the Code. A variable life insurance contract is considered variable on the same basis as a variable annuity contract and is subject to the same Code mandated restrictions and limitations with respect to the selection of investments.

From the perspective of the investor (i.e., prospective contract owner) entering into a PPVLIC, there are at least three additional material components in addition to the six material components to the process set forth immediately above concerning PPVDAC:
Selection of legal counsel to assist in estate planning relative to a PPVLIC, often including the establishment of a life insurance trust, an expensive and difficult process in part due to the fact that each trust deed is drafted uniquely and that counsel may be needed in multiple jurisdictions.
Selection of the state in which to establish a life insurance trust, a difficult process in part due to the complexity of the analysis and practical constraints.
Identification of trustee and negotiation with trustee and other service providers, a possibly impossible or difficult process due to the minimum investments typically required to obtain a recognized and qualified trustee and other service providers and lack of bargaining power.

Further, life insurance companies historically have required individual medical underwriting of PPVLICs, as opposed to group life insurance policies, in part, because of high minimum death benefits related to the high minimum premiums required.

To date market participants have failed to address the foregoing described issues and problems.

Background of the invention is contained in Publication WO 2008/092062.

### SUMMARY OF THE INVENTION

A platform and marketing and administration methodology that provides investment managers, insurance companies and broker-dealer/insurance agencies with the ability to maximize the marketing, sales, underwriting, IDF selection and creation and administration of privately placed, variable, deferred annuity contracts and variable life insurance contracts and to overcome the obstacles that have historically hindered those activities. The present invention is based upon privately placed, variable, deferred annuity contracts (which may include group annuities) (PPVDAC) and privately placed, variable life insurance contracts (which may include group life insurance contacts) (PPVLIC). The returns with respect to PPVDAC and PPVLIC are based upon the investment returns of certain privately placed investment funds (and may also be based upon investments funds registered under various securities laws) that are available generally only to insurance company separate accounts (IDFs). The methodology of the present invention, among other things, provides for the qualification of investors, the aggregation of investments by multiple investors, the negotiations of annuity and life insurance contracts and the selection and creation of investment funds in a manner that provides convenience and cost effective investment for investors in part through the rationalization of the legal documentation and process, while streamlining the marketing, sales and underwriting process.

A method of arranging a PPVDAC and PPVLIC are discussed in the present application (the “Method”). The Method includes, inter alia, negotiating with insurance companies for a standardized contract and evaluating the standardized contract and a plurality of investments by a plurality of specialists. The Method also includes performing legal, regulatory, due diligence, and compliance work with respect to the investments, and selling by brokers/insurance agents of a privately placed variable annuity or a life insurance contract to a prospect. In the Method, the prospect is able to select one or more of the investments (IDFs) and gain access to privately placed insurance contracts through the aggregation of the investment amounts of multiple investors. The Method performs this process through a programmed computer. Also, the management of contracts and related investments are activated through the use of a computer system and a database.

The Method is reified as a privately placed, tax deferred fund (“TDF™”), which is created by an agency relationship between the manager of the TDF (the “TDF Manager”) and each contract owner, together with a privately placed, co-mingled investment vehicle designed for cash management purposes as well as to allow the TDF to contract with third-party service providers while limiting the liability of the investors/contact owners (the “Administration Module”). The TDF may also be created by the use of a limited liability company, for example, formed under the laws of the State of Delaware, which eliminates the need for a power of attorney and provides for limitation of liability between the investor and the insurance companies and between the investor and the TDF Manager. Each such company would have a sole investor as a member and thus would constitute a disregarded entity under Reg. §1.7704-3(b)(1)(ii) under the Code, and the investor would be treated as the owner of the related PPVDAC or PPVLIC for Code purposes. Further, the TDF may also be created by the use of a multi-series limited liability company, for example, formed under the laws of the State of Delaware, which provides for complete limitation of liability between series as if each series was a separate juridical entity. In addition, multiple TDFs may be created utilizing a single such multi-series limited liability company and single Administration Module because each such series is segregated from each other series, and the group of series related to the investment performance of a certain IDF may properly be described as the TDF. The ability to utilize one such multi-series limited liability company to create multiple TDFs further enhances the efficiency and efficacy of the present invention. Each such series would have a sole investor as a member and thus would constitute a disregarded entity under Reg. §1.7704-3(b)(1)(ii) of the Code. Similarly, any other entity that is treated as a partnership under the Code could be utilized to create the TDF so long as each such entity had solely one “partner.” The use of a disregarded entity would still require the use of the Administration Module.

A TDF solely with respect to PPVLICs may also be created by using a series trust, for example, formed under the laws of the State of Delaware or the State of South Dakota, which provides for complete limitation of liability between series as if each series was a separate juridical entity. The trust structure allows for multiple beneficiaries and the appointment of a recognized and qualified trustee in a state that affords, among other advantages, for example, the benefits of allowing so-called “dynasty trusts” (i.e., trusts that do not have to comply with the generally recognized rule against perpetuities). Added to the advantages afforded by the TDF's aggregation of investments is the ability of the TDF Manager to engage a recognized and qualified trustee and other qualified service providers on commercially reasonable terms, as well as the ability of the investor to take advantage of standardized, high-quality trust documents, thereby saving significant legal fees and time. The use of a series trust would no longer strictly require the use of the Administration Module, though the use thereof would still be materially more efficient.

The offering documentation for TDFs regardless of the form of the TDF may be standardized and created in modules by means of a computer implemented process performed by a tangible computer device. In this way, only the variable information related to a particular IDF would need to be included in an explanatory memorandum or supplement (“IDF Variable Information”) to the master offering document created either for a standalone TDF or for multiple TDFs created under one multi-series limited liability company or series trust. Further, efficiency may be further enhanced by the creation of IDF offering documentation, as part of the present invention, where the IDF Variable Information would represent an explanatory memorandum or supplement to the IDF's offering documentation. This methodology would save significant legal time and expense while decreasing inconsistencies and errors.

As the TDF would be an agent for the investor either through the power of attorney or the disregarded entity, the TDF Manager would be subject to the investor control doctrine. The Registrants an the Dual Registrants are agents of the Dual Registered Entities (as defined and described below), and the Dual Registrants and Dual Registered Entities are agents of the life insurance companies. Therefore, the TDF facilitates Dual Registered Entities or their affiliates acting as IDF advisors or investment managers, as their acting as a TDF Manager would otherwise implicate violations of the investor control doctrine.

The effectiveness and efficiency of the TDF is dependent upon the use of a computer. The creation of the TDF requires the execution of multiple insurance contracts, the formation of multiple limited liability companies (limited partnerships or trusts) or execution of multiple powers of attorney, the drafting of multiple offering memoranda or supplements, the creation of multiple series of such limited liability companies, limited partners and trusts, the processing of multiple subscription agreements and related insurance applications, the receipt of subscription funds for multiple investors and the calculation of the allocation of such funds between multiple life insurance companies and to the Administration Module(s) and from the Administration Module(s) to the various service providers. The creation of operation of the TDF further requires the use of a computer to calculate pre and post tax investment returns and to calculate the economic impact of transfers between insurance companies under section 1035 of the Code.

In the Method, the establishment of the TDF is the initial step prior to the step of selling.

### BRIEF DESCRIPTION OF THE DRAWINGS

FIG. 1 is a flow chart illustrating a conventional method of forming a privately placed variable annuity.

FIG. 2 is a flow chart extending the flow chart of FIG. 1 and illustrating a conventional method of forming a privately placed variable annuity.

FIG. 3 is a flow chart extending the flow chart of FIGS. 1 and 2 and illustrating a conventional method of forming a privately placed variable annuity.

FIG. 4 is a flow chart extending the flow chart of FIGS. 1-3 and illustrating a conventional method of forming a privately placed variable annuity.

FIG. 5 is a diagram illustrating a method of forming a privately placed variable annuity according to the present invention made concrete as the TDF through the use of powers of attorney.

FIG. 6 is a diagram illustrating a method of forming a privately placed variable annuity according to the present invention made concrete as the TDF through the use of a multi-series limited liability company.

FIG. 7 is a diagram illustrating a method of forming a privately placed variable annuity according to the present invention made concrete as multiple TDFs through the use of a multi-series limited liability company.

FIG. 8 is a diagram illustrating a method of forming a privately placed variable annuity according to the present invention made concrete as the TDF through the use of a multi-series limited liability company where the TDF is a fund of funds.

FIG. 9 is a diagram illustrating a method of forming a privately placed variable life insurance contract according to the present invention made concrete as the TDF through the use of a series trust. All of the variations represented by FIGS. 5-9 also apply to privately placed variable life insurance contracts.

FIG. 10 is a diagram illustrating a method of creating the offering documentation for TDFs regardless of the form and IDFs in standardized form with supplements or explanatory memoranda related to variable information in the same or substantially similar form.

FIG. 11 is a diagram illustrating the interaction of the TDF in where a Dual Registered Entity (including an affiliate) acts as an IDF manager.

FIG. 12 is a diagram illustrating the usage of the TDF as a method of risk management in regards to insurance carrier exposure.

FIG. 13 is a simplified block diagram of the TDF Computer System 500-2 for the calculation of fees, the allocation of investment funds and other outputs with the regards to the TDF.

FIG. 14 is a simplified block diagram of the data flow structure of the Report and Fee Calculations Module.

FIG. 15 is a simplified block diagram of the data flow structure of the Investment Allocation Module.

FIG. 16 is a flow chart illustrating the method of forming a privately placed variable annuity through the use of the present invention including the use of a computer system designed to implement the specific needs of the proposed invention.

FIG. 17 is a representative output of the Report and Fee Calculations Module to be sent to an annuitant.

### DETAILED DESCRIPTION

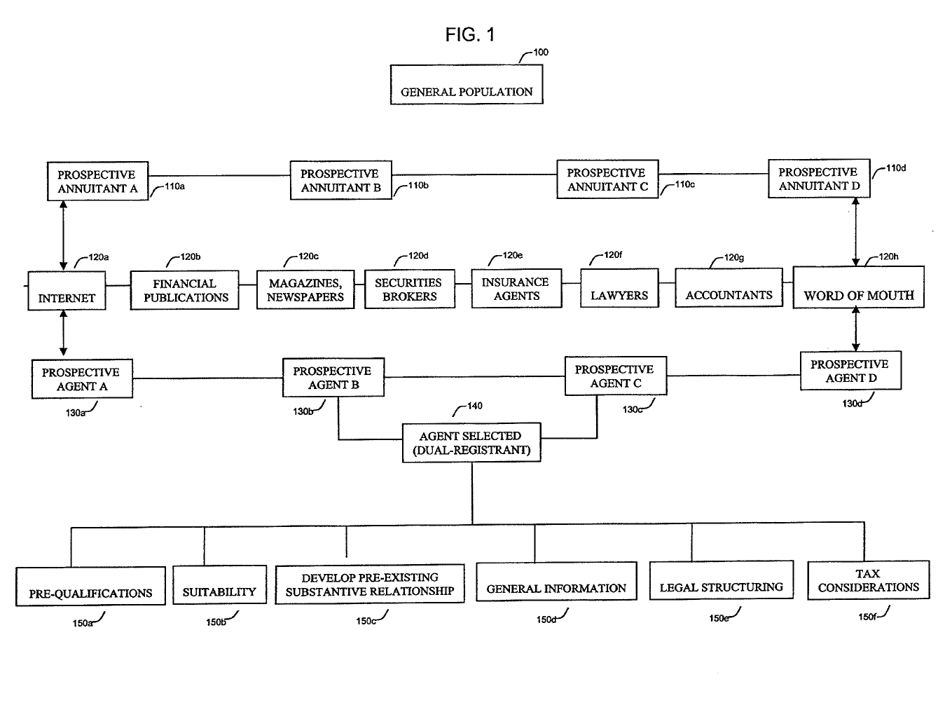

A flow chart showing a Traditional Private Placement Variable Annuity (PPVA) is shown in FIG. 1. Prospective Annuitants within the general population may seek multiple and often competing sources of information to identify PPVA issues. An agent may likewise seek to identify from its customers or the general population prospective annuitants utilizing several of the same sources. Upon identification of prospective annuitants by an agent, or vice-versa, the agent may perform various tasks. If a client is interested, the client may engage advisors to review different policies, issues, etc. This may be a long, cumbersome process taking 3-6 months with many fees. Contract negotiation may also be another long cumbersome process which may take an additional 3-6 months and continues to be fee intensive due to multiple advisors.

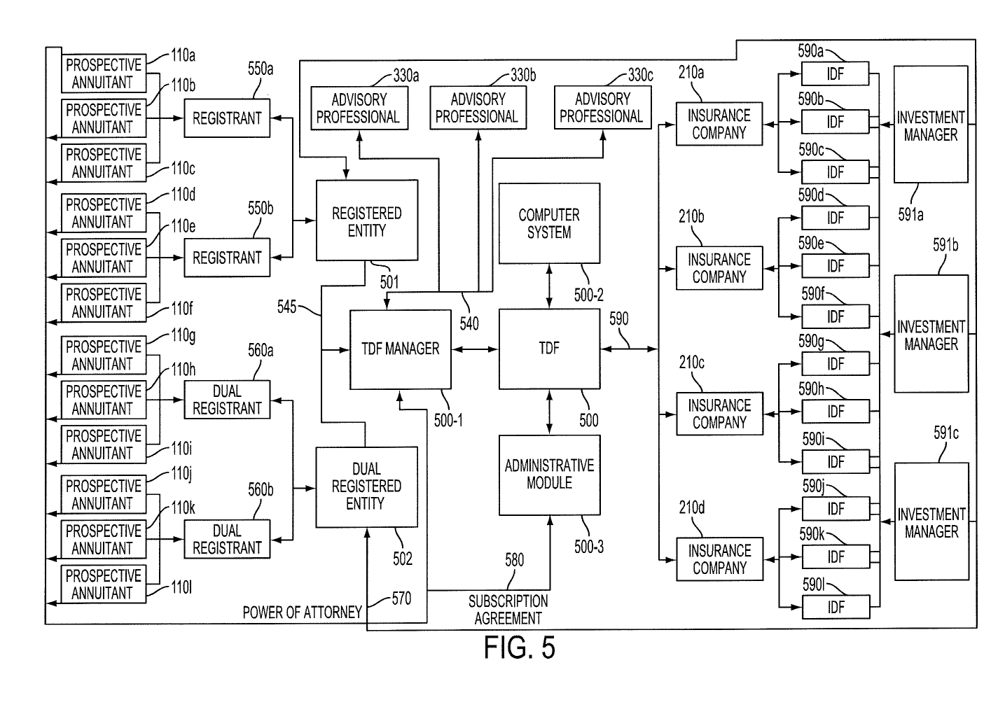

A flow chart for the proposed invention of a TDF is shown in FIG. 5. The TDF Manager is a module that screens insurance companies, negotiates favorable terms for broadly applicable standardized contracts, performs due diligence on and selects insurance dedicated funds (IDFs). The TDF Manager addresses all other legal, accounting, tax and wealth advisory issues and creates an offering memorandum and related documentation for the TDF product, comprising in the order of 100 hundred pages as opposed to over 5,000 pages related to a Traditional Private Placement Variable Annuity. The TDF Manager also selects life insurance agencies that are registered broker-dealers under federal and state securities laws and licensed under state insurance laws (“Dual Registered Entities”) and the related employees that are likewise registered under federal and state securities laws (“Registrants”) or registered under federal and state securities laws and licensed under state insurance laws (“Dual Registrants”). The TDF Manager does all legal, regulatory and compliance work, and also performs initial and ongoing due diligence with respect to existing and future IDFs and their investment managers. In performing these functions, the TDF Manager employs computer programs and the information stored in its data bases to track IDF and PPVDAC performance. Computer databases and models are also be used to calculate the economic impact of desirable or necessary switches between insurance companies or PPDVAC (so called Code section 1035 transfers).

FIG. 1 relates to a flow chart for a traditional private placement variable annuity. Box 100 of FIG. 1 illustrates a general population, and which connects to boxes 110a through 110d. 110a illustrates a prospective annuitant A, 110b illustrates a prospective annuitant B, 110c illustrates a prospective annuitant C and 110d illustrates a prospective annuitant D. Each of the prospective annuitants connects to each of boxes 120a through 120h. Boxes 120a through 120h illustrate the different sources of information relating to private placement variable annuities (PPVA). Elements 120a through 120h include, but are not limited to, the Internet, financial publications, magazines, newspapers, securities brokers, insurance agents, lawyers, accountants, and word of mouth. Elements 130a through 130d of FIG. 1 illustrate prospective agents. Each prospective agent may be contacted by one or more prospective annuitants who are interested in purchasing or contracting for a PPVA. Element 140 in the flow chart illustrates that the agent has been selected among the different prospective agents by the particular prospective annuitant. The selected agent 140 may perform any of the functions illustrated in elements 150a to 150f. Elements 150 include, but are not limited to, pre-qualifications, suitability, developing pre-existing substantive relationships, general information, legal structuring, and tax considerations.

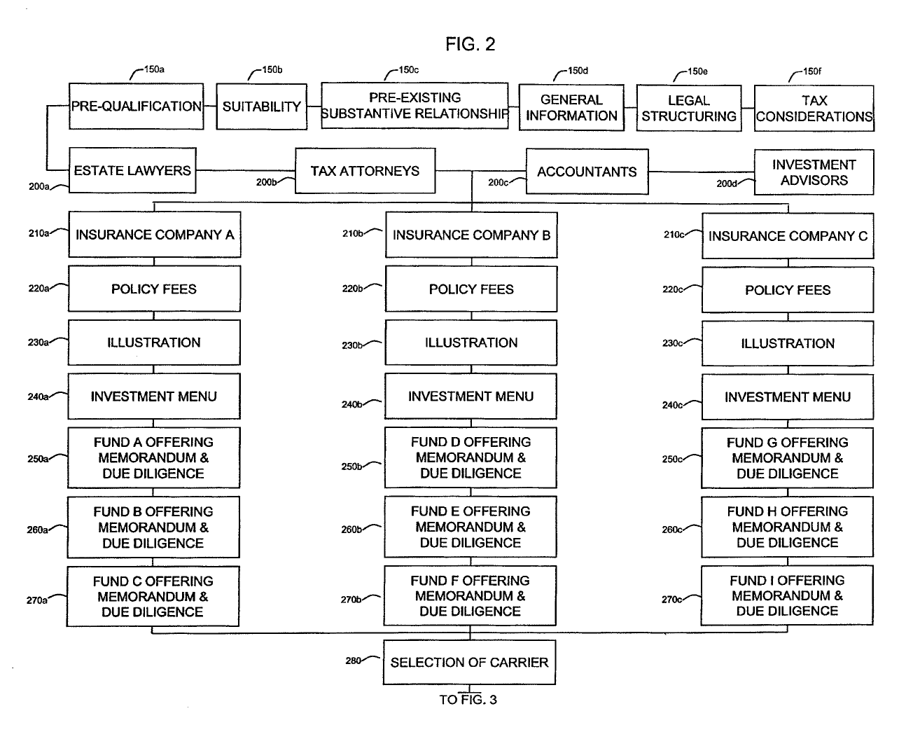

FIG. 2 illustrates a continuation of the flow chart illustrated in FIG. 1. Elements 150a to 150f are shown again at the top of FIG. 2. Each of elements 150a to 150f connects to elements 200a to 200d. Elements 200a to 200d may include, but are not limited to, registered advisors and or agents including, estate lawyers, tax attorneys, accountants, and investment advisors. Each of elements 200a to 200d, representing advisors and agents to the annuity agent, evaluate insurance companies to determine the best place to purchase the annuity contract and/or insurance contract. This relationship is illustrated in FIG. 2 in which insurance companies A through C are shown connected to elements 200a to 200d. Insurance company A is shown as element 210a and is connected to elements 220a which are policy fees. Also arranged under insurance company A are illustration 230a, investment menu 240a, fund A offering memorandum and due diligence 250a, fund B offering memorandum and due diligence 260a, and fund C offering memorandum and due diligence 270a. Insurance company B has arranged under it elements 220b, 230b, 240b, 250b, 260b, and 270b, comprising the same elements discussed with regard to insurance company A. Likewise, insurance company C includes the same elements discussed with regard to insurance companies A and B. Also other insurance companies may be reviewed by the advisors 200a-d. After the advisors have evaluated the insurance companies a selection of carrier, as shown in Box 280, is made.

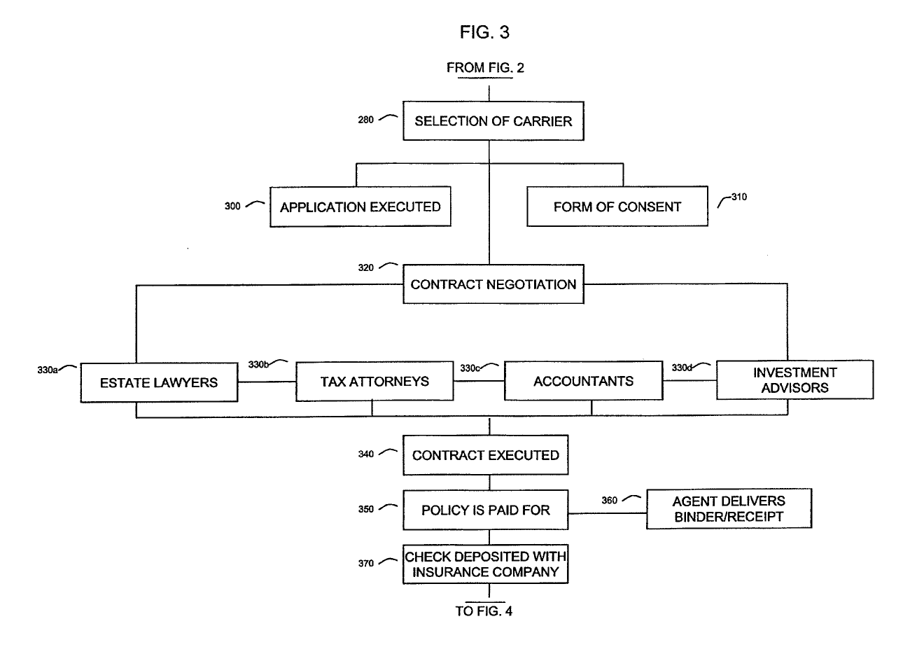

FIG. 3 continues the same flow chart illustrated in FIGS. 1 and 2. Selection of carrier 280 is shown at the top of FIG. 3. A selection of carrier 280 connects to application executed 300 and form of consent 310. Application executed 300 may involve various application procedures specific to the insurance company. The selection of carrier proceeds to contract negotiation 320 which may involve various investment advisors 330d, accountants 330c, tax attorneys 330b, and estate lawyers 330a, as well as any number of other specific advisors. All of the advisors 330 may be involved in executing the contract as shown in element 340. Element 350 follows element 340. Element 350 indicates that the policy is paid. Element 360 follows element 350 and indicates that the agent delivers a binder, or receipt. Also following element 350 is element 370 indicating that the check is deposited with the insurance company.

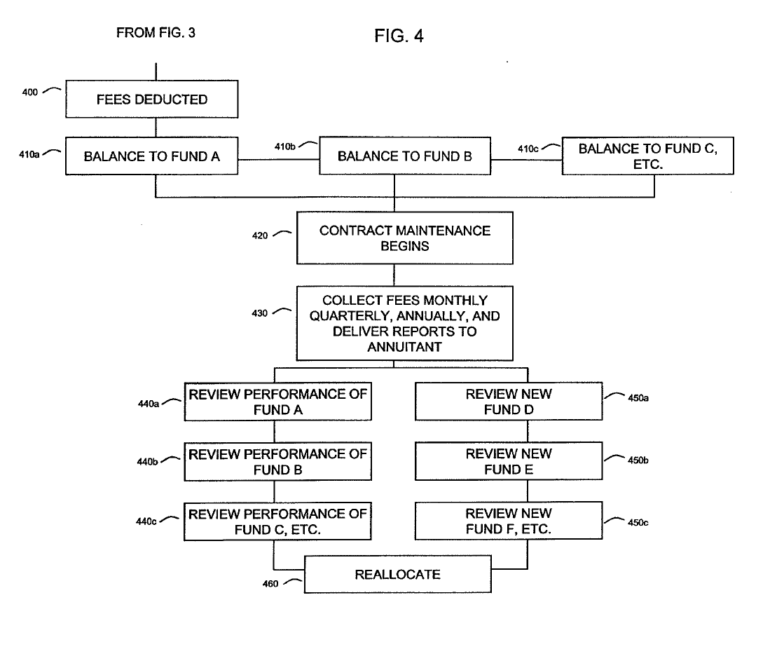

FIG. 4 illustrates a continuation of the flow chart illustrated in FIGS. 1-3. Following element 370 of FIG. 3 is element 400 of FIG. 4 indicating that fees are deducted. These deducted fees may include investment management fees. Following element 400 are elements 410a, 410b, and 410c. Each of the elements 410 indicate a balance is forwarded to a corresponding fund. The flow from elements 410 in the Figure goes to element 420 indicating that contract maintenance begins. The flow from element 420 is to element 430 indicating to collect fees monthly, quarterly, annually, and to deliver reports to the annuitant. From element 430 the flow proceeds to review of particular funds as shown in elements 440a, 440b, and 440c. Also the flow proceeds as well to a review of new funds as shown in elements 450a, 450b, and 450c. The flow from all of elements 440a-c and 450a-c goes to element 460 which indicates to reallocate the monies in the different funds. The reallocation of element 460 may be based on any number of investment considerations including risk, return, or any other investment consideration.

FIG. 5 is a diagram that illustrates according to the proposed invention relating to private placement variable annuities. In the present invention as illustrated in FIG. 5, many of the functions shown in FIGS. 1-4 are consolidated and stream-lined in order to improve efficiency. FIG. 5 illustrates a broker-dealer registered under federal and state securities laws (“Registered Entities”) 501 and a life insurance agency that is a registered broker-dealer under federal and state securities laws and licensed under state insurance laws (“Dual Registered Entities”) 502 and the related employees that are likewise registered under federal and state securities laws (“Registrants”) 550a-b (where the Registrants do not receive any insurance commission) or registered under federal and state law and licensed under state insurance laws (“Dual Registrants”) 560a-b (where the Dual Registrants may receive insurance commissions) and Registered Entities and Dual Registered Entities, etc. indicating more Dual Registered Entities. Each of the Registered Entities and Dual Registered Entities is selected by the TDF Manager 500-1 on behalf of the TDF 500. Each of the Registrants 550 and Dual Registrants 560 may be selected by the TDF Manager 500-1 as part, and on behalf, of the TDF 500 or may be selected by its Registered Entity 501 or Dual Registered Entity 502 employer. Each of the Registrants and Dual Registrants is connected to the TDF Manager through its related Registered Entity or Dual Registered Entity shown by line 545. The selection of the Registered Entities 501 and Dual Registered Entities 502 (where the Registrants do not receive any insurance commissions) by the TDF Manager 500-1 is performed with the assistance or a computer system shown as line 500-2. 110a illustrates a prospective annuitant a, 110b illustrates a prospective annuitant b, 110c illustrates a prospective annuitant c and 110d illustrates a prospective annuitant d. Each of the annuitants connects solely to the TDF 500 through a limited power of attorney granted to the TDF Manager module 500-1 shown by line 570 and to the TDF Administration Module 500-3 through a subscription by the annuitant with the TDF Administration Module shown by line 580, though the prospective annuitants are first introduced to the TDF 500 through Registrants 550a-b and Dual Registrants 560a-b of the Registered Entities 501 and Dual Registered Entities 502 by the TDF Manager 500-1. The TDF Manager may have relationships with various insurance companies as shown by double-headed arrow 590 connecting the TDF 500 with insurance company a, insurance company b and other insurance companies. The TDF Manager 500-1 may screen the insurance companies 210a-d and negotiate favorable terms for broadly applicable standardized contracts, and performs due diligence on and selects insurance dedicated funds (IDFs) 590a-I. The IDF connects to the Insurance Companies 210a-d and to the investment managers 591 of the IDFs (“IDF Managers”) 590a-I as well as the Registered Entities 501 and Dual Registered Entities 502. TDF Manager 500-1 may perform these functions with the assistance of various inputs. For instance the TDF Manager 500-1 may interact with advisory accountant information 330c, advisory estate planning information 330a, advisory tax information 330b and other advisory information. The interactions between the TDF Manager 500-1, the TDF Computer System 500-2 and the TDF Administrative Module 500-3 create and comprise the TDF 500.

The interaction between the TDF Manager module 500-1 and advisory input information 330 is shown as double-headed arrow 540. Double-headed arrow 540 is performed utilizing a computer database. The advice of the advisory input information 330 assist the TDF Manager module 500-1 on legal, accounting, tax and wealth advisory issues in the reification of the Method into a standardized multi-purpose product in the form of the TDF. The TDF Manager 500-1 selects IDFs 590. The TDF Manager module 500-1 selects the different IDFs, for instance, IDF a illustrated in Box 590a or the other IDFs 590 based on a performance, risk or other concerns. The TDF Manager 500-1 may select an IDFs 590 based on interaction evaluation 590 shown as a double-headed arrow. Interaction 590 evaluation is performed using a computer database which accesses the investment analytics information. The TDF Manager module 500-1 may perform all legal, regulatory, and compliance work and may perform due diligence for existing and potential new IDF Managers 591-a-c. The TDF Manager 500-1 module may interact with insurance company data 210 via interaction evaluation 590. Interaction evaluation 590, illustrated by a double-headed arrow, based on a computer analysis through the Computer System 500-2.

A significant advantage of the present invention is the economy of scale based upon performing the different professional functions, selection functions, and other analysis, being leveraged for more than one annuitant. By commoditizing the variable annuity for prospective annuitants, the present invention allows annuitants to increase their rate of return, eliminating or minimizing expenses associated with the traditional process and increases legal certainty. Additionally, the present invention also enables providers, including insurance companies and brokers/insurance agencies, to reduce their overhead cost and leverage their existing knowledge to provide improved service at a lower cost.

Each of the previously discussed aspects of private placement variable annuities of the present invention is also applicable to life insurance. For instance, life insurance may be purchased in the same manner as discussed in FIGS. 1-4 above. Utilizing the present invention, private placement variable life insurance may be offered for sale and purchased in the same manner as shown in FIG. 5. For instance, a TDF Manager module may interact with Registered Entities and Dual Registered Entities who sell interests in the TDF to prospective purchasers. The TDF Manager module may interact with insurance companies in the same manner as shown in FIG. 5. It a also contemplated that the TDF Manger module could utilize group life underwriting standards to simplify and broaden application of the present invention. The TDF Manager module may also interact with input information in the same manner as shown in FIG. 5 with the variation that information in insurance would also be accessed by the TDF Manager module. The TDF Manager module may also interact with IDFs insurance dedicated funds as shown in FIG. 5.

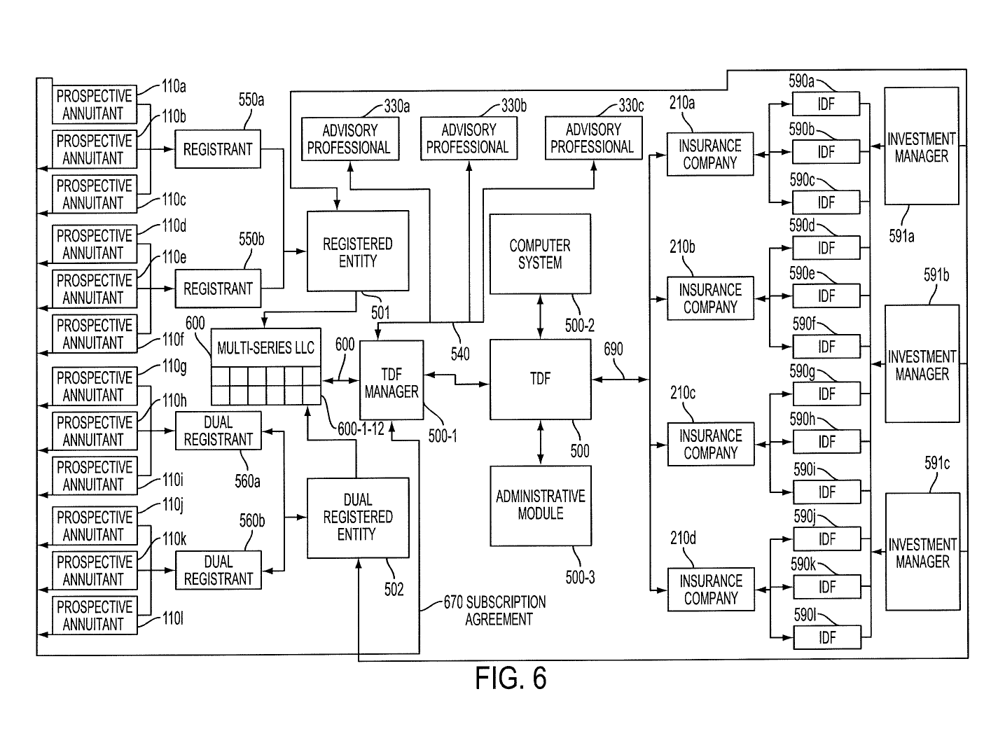

FIG. 6 is diagram that illustrates the proposed invention relating to private placement variable annuities and is the same in all respects as FIG. 5, except that the TDF utilizes a multi-series limited liability company 600 with each series solely owned by one annuitant/investor. Each of the annuitants connects to the TDF solely through a series of the limited liability company 600-1-12 through a subscription with the TDF 500 solely with respect to such series shown by line 670, though the prospective annuitants are first introduced to the TDF 500 through the Registrants 550a-b and Dual Registrants 560a-b of the Registered Entities 501 and Dual Registered Entities 502 by the TDF Manager module 500-1. The series of the limited liability company 600 component of the TDF 500 may interact with insurance companies 210 via interaction information 690. Interaction information 690, illustrated by a double-headed arrow, is based in part on a computer analysis through the Computer System 500-2. Each series 600-1-12 or limited liability company is a disregarded entity under the Code; therefore, each Prospective Annuitant upon the execution of a variable annuity contract by the series owned by such Prospective Annuitant becomes an annuitant under the Code entitled to the benefits of section 72 thereunder. The interactions between the TDF Manager 500-1, the TDF Computer System 500-2, the TDF Administrative Module 500-3 and the TDF Multi-Series LLC and each series 600-1-12 create and comprise the TDF 500.

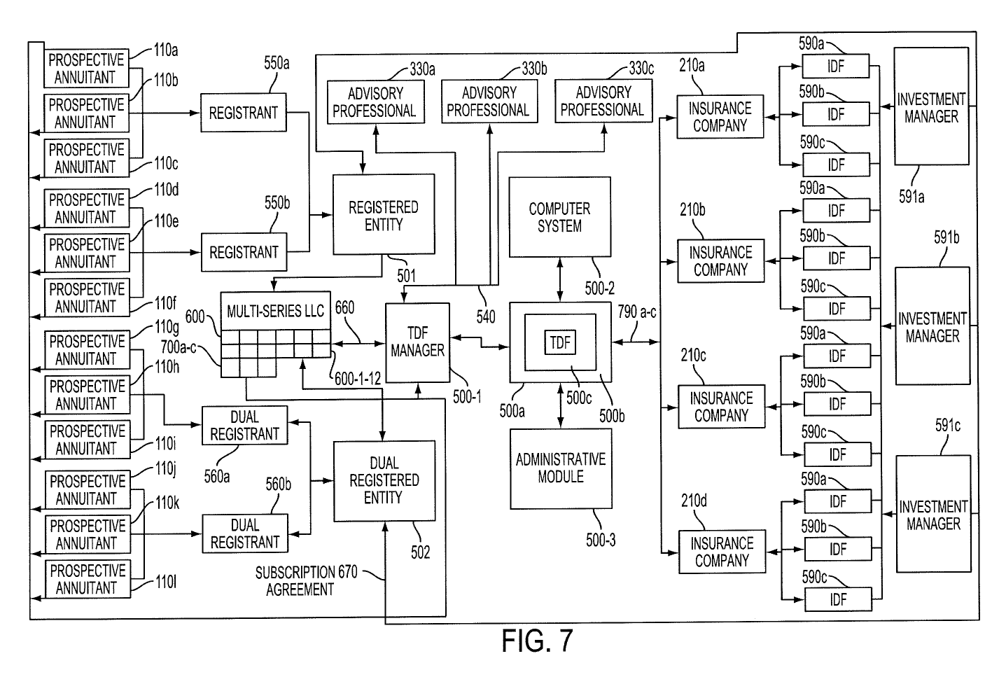

FIG. 7 is diagram that illustrates the proposed invention relating to private placement variable annuities and is the same in all respects as FIG. 6, except that multiple TDFs 500-a-c utilize a single Multi-Series LLC 600 with each series 600-1-12 solely owned by one annuitant/investor. Various series of the limited liability company components 600-1-12 of the TDF 500a-c may interact with insurance companies 210 via interaction information 790a-c which relate to various IDF components 590a, 590b, 590c. Interaction information 790 illustrated by a double-headed arrow, is based in part on a computer analysis through the Computer System 500-2. Each series 600-1-12 of the limited liability company is a disregarded entity under the Code; therefore, each Prospective Annuitant upon the execution of a variable annuity contract by the series owned by such Prospective Annuitant becomes an annuitant under the Code entitled to the benefits of section 72 thereunder. The interactions between the TDF Manager 500-1, the TDF Computer System 500-2, the TDF Administrative Module 500-3 and the TDF Multi-Series LLC 600 and each group of series 700a-c create and comprise the related TDFs 500a, 500b, 500c.

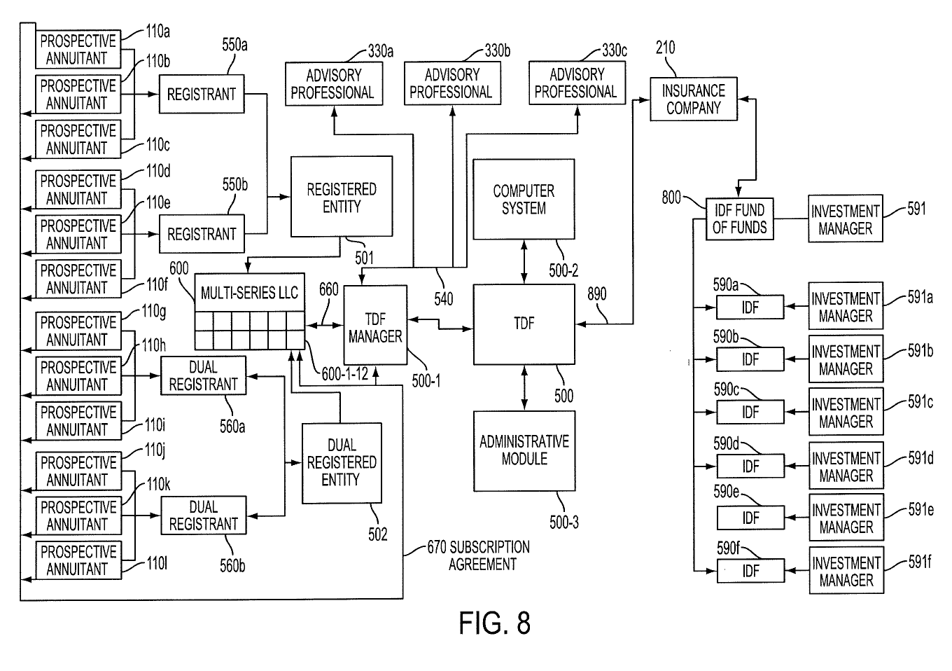

FIG. 8 is a diagram illustrating a method of forming a privately placed variable annuity according to the present invention made concrete as the TDF through the use of a Multi-Series LLC 600 where the TDF is a fund of funds. Each series 600-1-12 of a multi-series limited liability company 600 is solely owned by one annuitant/investor. Each of the annuitants connects to the TDF solely through a series of the TDF limited liability company 600 through a subscription with the TDF 500 solely with respect to such series shown by line 670, though the prospective annuitants are first introduced to the TDF 500 through the Registrants 550a-b and Dual Registrants 560a-b of the Registered Entities 501 and the Dual Registered Entities 502 by the TDF Manager module 500-1. The series of the TDF limited liability company 600 component of the TDF 500 may interact with insurance companies 210 via interaction information 890. Interaction information 890, illustrated by a double-headed arrow, is based in part on a computer analysis through the TDF Computer System 500-2. In order to gain exposure to a diversified portfolio of single strategy IDFs and thereby reduce the fees and expense related to investing in an IDF structured as a fund of funds, the TDF Manager selects numerous IDFs with respect to the annuity contract(s) owned by a series and provides that each series will have the substantially the same exposure to such IDFs.

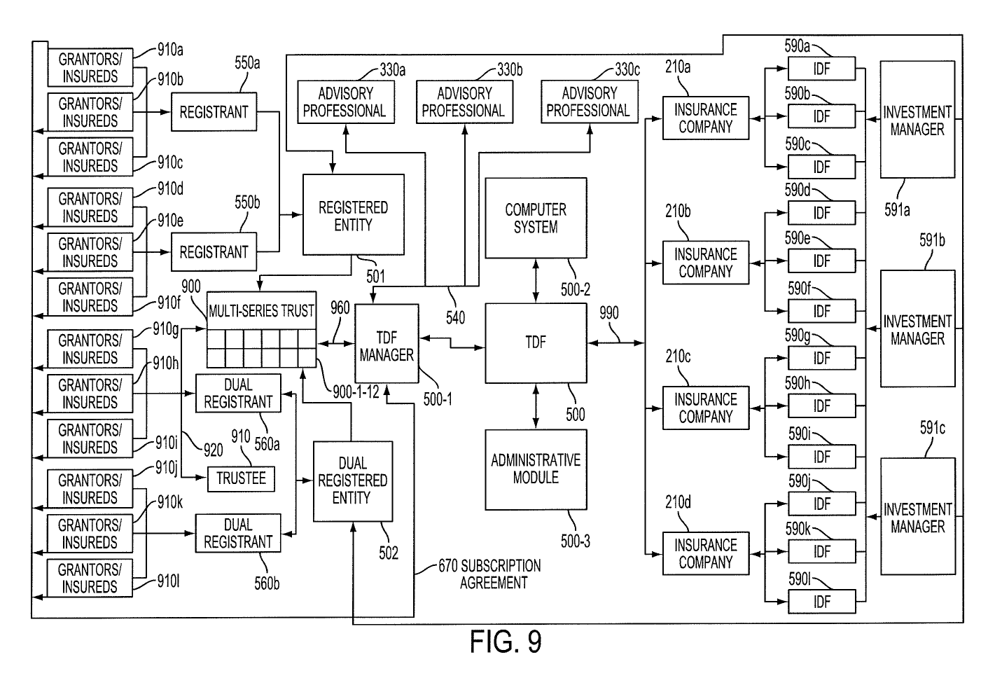

FIG. 9 is diagram that illustrates the proposed invention relating to private placement variable life insurance contracts and is the same in all respects as FIG. 6, except that the TDF utilizes a series trust 900 with multiple series 900-1-12 with one or more beneficiaries of each series. The TDF Manager connects solely with the Multi-Series Trust 900 through an investment management agreement 960, and the trustee 910 connects solely to the trust 900 and to each the series through the deed of trust and each supplemental deed represented by the double headed arrow 920. Each of the grantors/insureds 910a-I connects to the TDF solely through a series of the trust 900-1-12 through a subscription with the TDF 500 solely with respect to such series shown by line 670, though the prospective grantors/insureds are first introduced to the TDF 500 through the Registrants 550a-b (where the Registrants due not receive any insurance commissions) and Dual Registrants 560a-b (where the Dual Registrants may receive insurance commissions) of Registered Entities 501 and of the Dual Registered Entities 502 by the TDF Manager module 500-1. Each of the grantors/insureds connects to the TDF solely through a series of the trust 900-1-12 through the deed of trust and a supplemental deed 900-1-12.

The series of the trust 900 of the TDF 500 may interact with insurance companies 210 via interaction information 990. Interaction information 990, illustrated by a double-headed arrow, is based in part on a computer analysis through the Computer System 500-2. Each series of the trust with more than one beneficiary/owner is treated as a partnership under the Code. The interactions between the TDF Manager 500-1, the TDF Computer System 500-2, the TDF Administrative Module 500-3 and the TDF Series Trust 900, the Trustee 910 create and comprise the TDF 500.

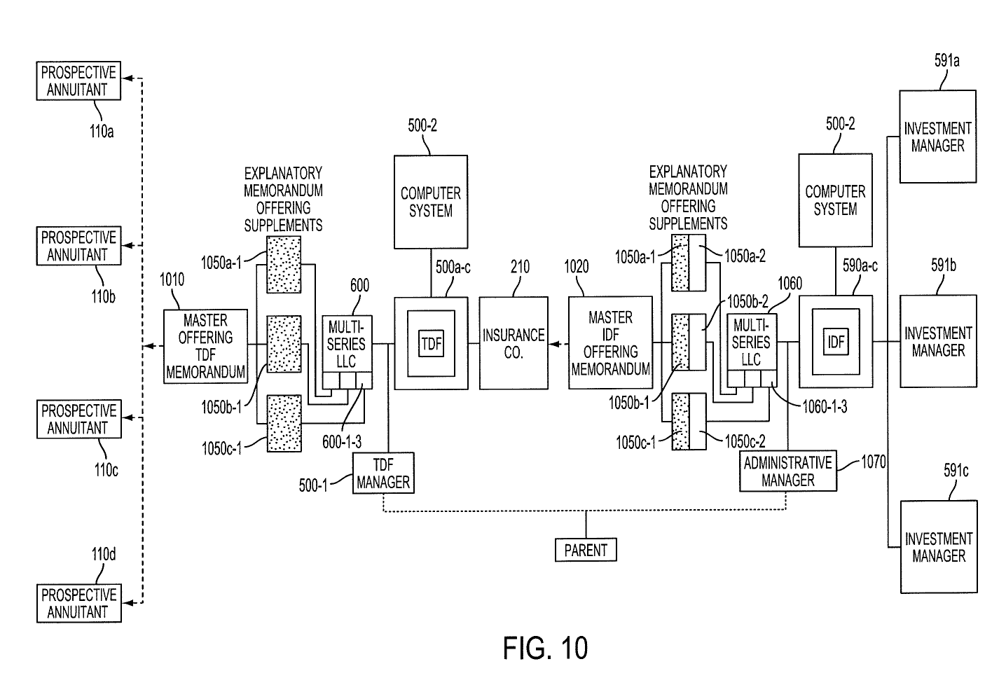

FIG. 10 is a diagram illustrating the offering documentation for TDFs regardless of the form of the TDF created as a master offering memorandum TDF OFF 1010 with supplements or explanatory memoranda EM 1050 a-1, b-1, c-1 containing only the variable information related to a particular IDF being included in a supplement or explanatory memorandum to the master offering memorandum TDF OFF 1010 the Administrative Manager of the IDFs 590a-c maybe an affiliate of the TDF Manager 500-1 where the explanatory memoranda EM 1050 a-1, b-1, c-1 would be attached to the related master offering memorandum of the IDFs 1020, together with additional variable information related to a particular IDF 590a-c being included in a supplement or explanatory memorandum 1050a-2, 1050b-2, 1050c-2.

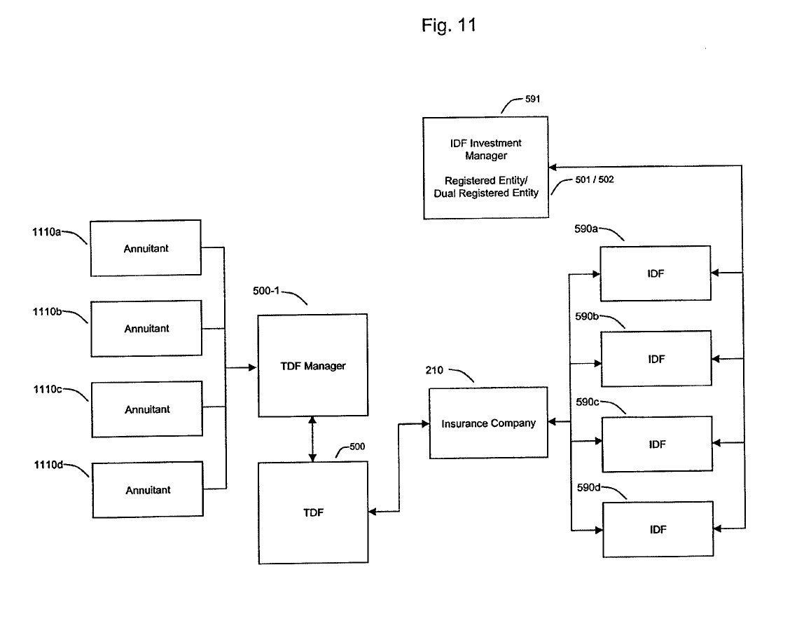

FIG. 11 is a diagram illustrating the interactions of the TDF 500 (which is described in FIG. 5 as being comprised of the TDF Manager 500-1, the TDF Computer System 500-2 and the TDF Administrative Module 500-3; and in FIG. 6 as being comprised the TDF Manager 500-1, the TDF Computer System 500-2, the TDF Administrative Module 500-3 and the TDF Multi-Series LLC 600) in which a Registered Entity 501 or Dual Registered Entity 502 acts as the investment manager of IDFs 590a-d. Annuitants 1110a-d entered into variable annuity contracts through the TDF 500 with the insurance company 210. The TDF through the use of the TDF Manager 500-1 selects IDFs 590a-d to be the reference investments for Annuitants 1110a-d. The Registered Entity or Dual Registered Entity does not provide the TDF or any Annuitant with information on the quality or rate of return of any investment or group of investments contained in IDFs 590a-d, and TDF does not provide to the insurance company 210 information on whether it should appoint the Registered Entity, the Dual Registered Entity or any other person to act as the investment manager of any IDF or on whether the insurance company should make available any particular investment strategy or IDF as an investment option. Neither the Registered Entity, the Dual Registered Entity or any of the Registrants 550a-b or the Dual Registrants 560a-b provides information to the Annuitants 1110a-d on the quality or rate of return of any investment or group of investments contained in IDF 590a-d. The TDF is not an affiliate of the Registered Entity or Dual Registered Entity and in any iteration of the invention constitutes a different entity under the Code from the Registered Entity or Dual Registered Entity and further serves to isolate the Registered Entity or Dual Registered Entity from the Annuitants to prevent violation of the “investor control doctrine” discussed above.

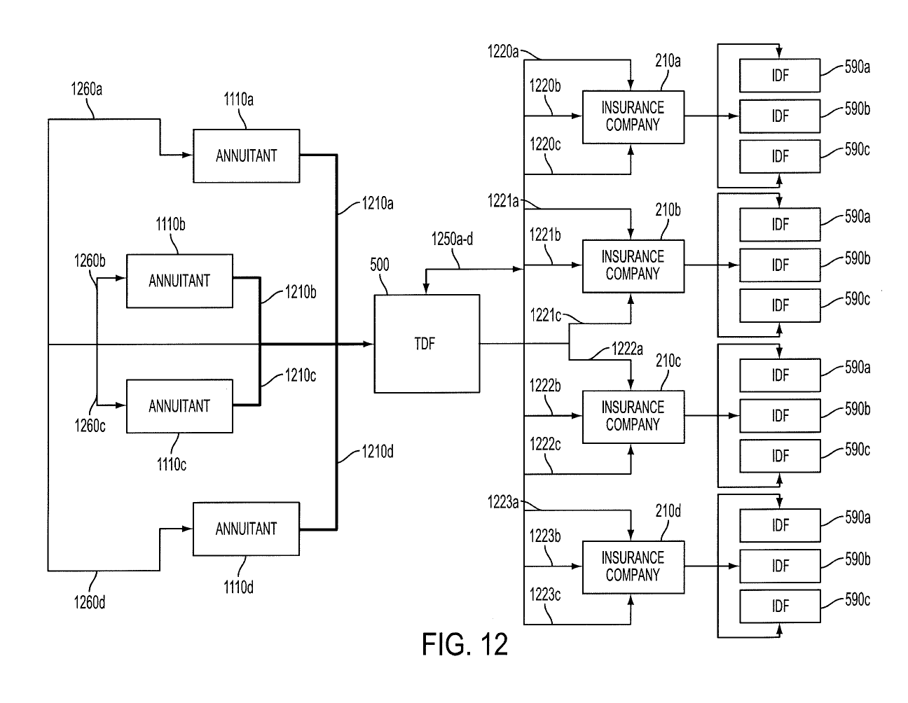

FIG. 12 is a diagram illustrating the usage of the TDF as a method of risk management with regard to insurance company exposure. Where each of the annuitants 1110a-d desires to select an offered IDFs, for example, IDF 590a-c, respectively. Line 1210a-d shows the subscription/investment amount flowing from annuitants' 1110a-d into the TDF 500. Lines 1220a-c-1223a-c show the total subscription/investment amounts 1110a-d, respectively, being split by the TDF 500 and then distributed out to different insurance companies 210a-d, where the selected IDFs are offered by multiple insurance companies. The continuation of lines 1220a-c-1223a-c describes the final allocations of the subscription/investment amounts to those IDFs through the insurance company separate accounts. Double arrow lines 1250a-d represent the ongoing tracking and of the aggregated investments. Lines 1260a-d describe the reaggregation of the information from the various investments and insurance companies into a comprehensive report with information necessary to access carrier risk exposure, while at the same time providing complete information concerning investment performance metrics. Given the high minimum investment amounts typically required by insurance companies with respect to privately placed insurance contracts, without the ability of the TDF to aggregate investments by numerous annuitants, it would be impossible to mitigate risk because dividing subscription/investment amounts between insurance companies would normally reduce the amounts allocated to below the required minimums.

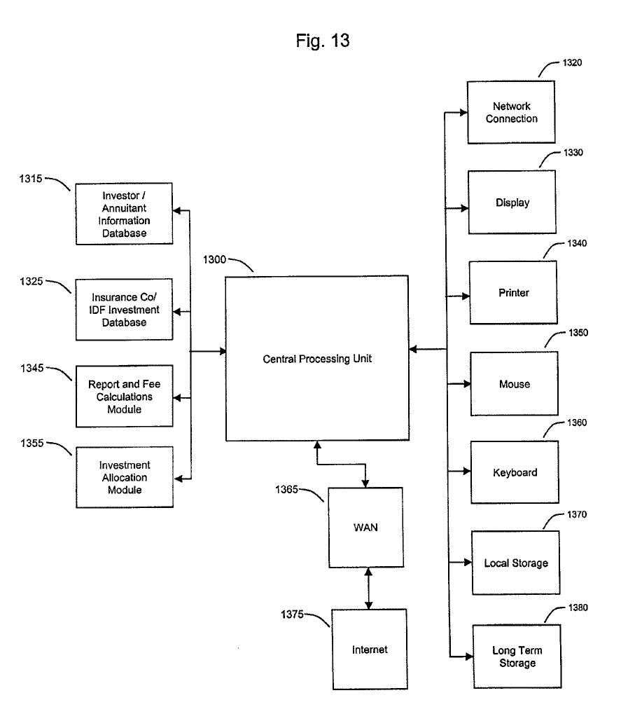

FIG. 13 is a simplified block diagram of the TDF Computer System, 500-2 from above, for the calculation of fees, the allocation of investment funds and other outputs with the regards to the TDF. The TDF Computer System includes a Central Processing Unit 1300, a Network Connection 1320, a Display 1330, a Printer 1340 for when hard copy output is necessary, a Computer Mouse 1350 and Keyboard 1360 for system level input, Local Storage 1370 for the execution of proposed systems, Long-Term Storage 1380 for the for the retention of Databases and post processed output, access to a wide area network (WAN) 1365 with a further Connection to the Internet 1375 (or “Cloud”), Investor/Annuitant Information Database 1315, Insurance Company/IDF Investment Database 1325, Report and Fee Calculation Module 1345 and Investment Allocation Module 1355.

Referring further to FIG. 13 the dataflow between some of the major computer system components, Annuitant information and other related information is received over the Connection to the Internet 1375 and/or the WAN 1365. In the embodiment of the invention, the central processing unit is current generation multi-core processor operating. It is envisioned that the system will interact on a cross platform (multiple or operating system) environment.

Referring further to FIG. 13, there is shown an overview of the data flow between the system's major components. Annuity contract data is received Via the Internet (or Wide Area Network (WAN)) through the Network Connection 1320 (although the keyboard 1360 can be used whenever necessary to interact with the CPU it is also contemplated that a portable dual function, data entry and display device maybe be used in the future to facilitate mobile information gathering and entry.) Such data includes but is not limited to the name of the Annuitant, the age of the Annuitant, the date of birth of the Annuitant and the gender and address of the Annuitant. Data also includes, without limitation, investor suitability data (including, without limitation, whether the Annuitant is an accredited investor under Regulation D under the Securities Act of 1933, as amended, and a qualified purchaser under the Investment Company Act of 1940, as amended), subscription documents, date of desired investment, the subscription amount and choice of TDF, and fees and expenses of the TDF. Information will also be received and inputted from the insurance companies, which includes fees, cost of insurance, IDF investment performance and the investment performance of the privately placed insurance contracts.

Data is retrieved from the Investor/Annuitant Information Database 1315, the Insurance Company/IDF Investment Database 1325 and when the Report and Fee Calculation Module 1345 is activated by the system user. The Report and Fee Calculation Module 1345 performs various functions on information retrieved and outputs physically transformed data representing tangible values to Local Storage 1370 for further use at the system level and the Long Term Storage 1380. These functions include, without limitation, computation of the aggregate performance the IDFs in which the TDF invests, if more than one; of the performance of the TDF before and after deduction of fees and expenses with respect to each Annuitant; the amount of any taxable income generated by short-terms investments made by the TDF Administration Module; and the comparison of the performance of the TDF to relative to alternative taxable investments. Similarly, data is retrieved from the Investor/Annuitant Information Database 1315 and the Insurance Company/IDF Investment Database 1325, when the Investment Allocation Module 1355 executed by the forenamed conditions set out in the element of the Investment Allocation Module 1355. The Investment Allocation Module 1355 performs various functions on information retrieved and outputs physically transformed data representing tangible values to Local Storage 1370 from which data is further outputted to Local Storage 1370 for further use at the system level and the Long Term Storage 1380. These functions include, without limitation, computation of amount of the proceeds from the investment by the Investor/Annuitant to be allocated to the bank account of the TDF Administration Module 500-3 and to the various Insurance Companies for investment in the various IDFs; the comparative performance of the IDFs in which the TDF invests, if more than one; the comparative expenses of the PPVADCs in which the TDF invests, if more than one; and the compliance by the TDF of diversification requirements of section 817 of the Code.

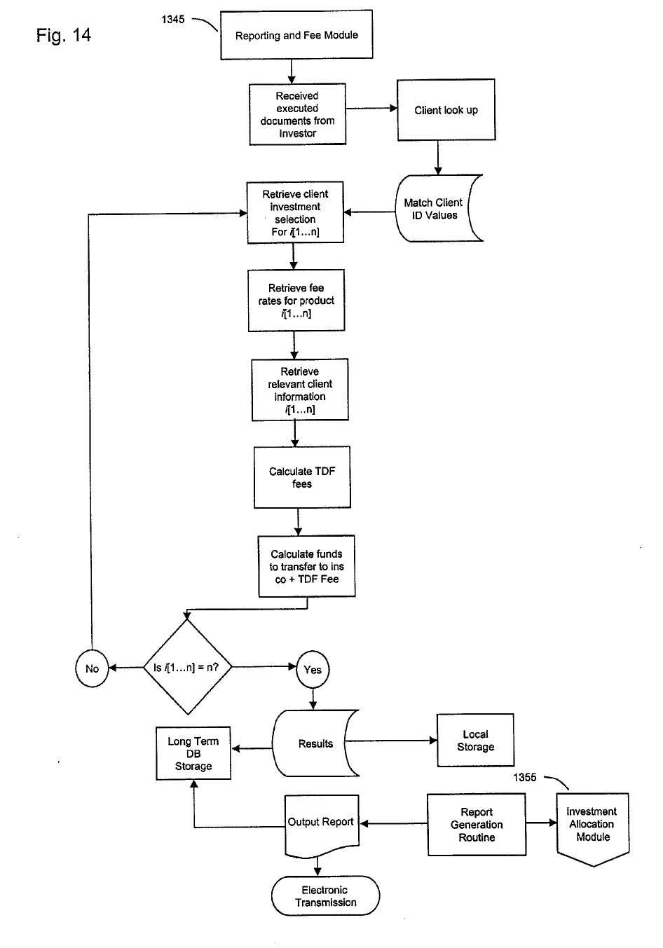

FIG. 14 is a simplified block diagram of the data flow structure of one of the routines of the Report and Fee Module. In this function the Reporting and Fee Module 1345 verifies Investor (Annuitant) data, confirms Investor identity, calculates TDF fees and calculates funds to be transferred to the Insurance companies and the TDF Administration Module, and generates an Output Report, and finally transmits that Output Report to the prospective annuitant and the related investment professionals. Once the report's reception is acted upon, i.e. the appropriate funds are wired into the TDF administration account, it will trigger the execution of the Investment Allocation Module 1355.

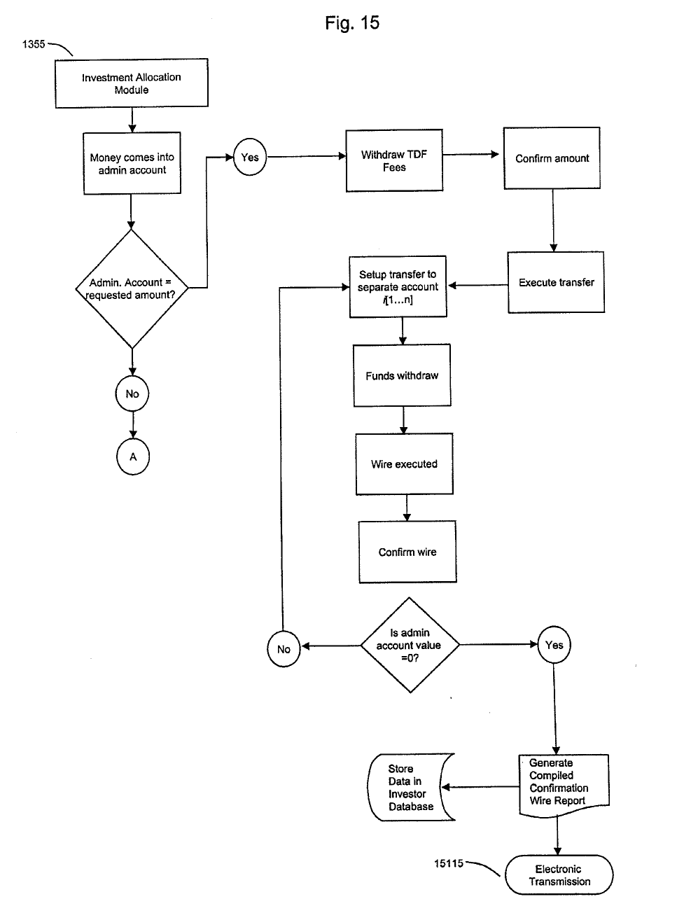

FIG. 15 is a simplified block diagram of a routine structure of one of the functions of the Investment Allocation Module 1355. In this function the Investment Allocation Module 1355 verified receipt of funds into the account of the TDF Administration Module and thereafter proceeds to apply the calculations done in the Reporting and Fee Module 1345 and test the conditions for automation of distribution of fund and movements of monies in compliance with the plurality of constraints a set forth by the TDF product. All completed calculations and post execution transformed metrics and set values are stored in Long Term Storage 1380 and inserted in the Investor Database 15015.

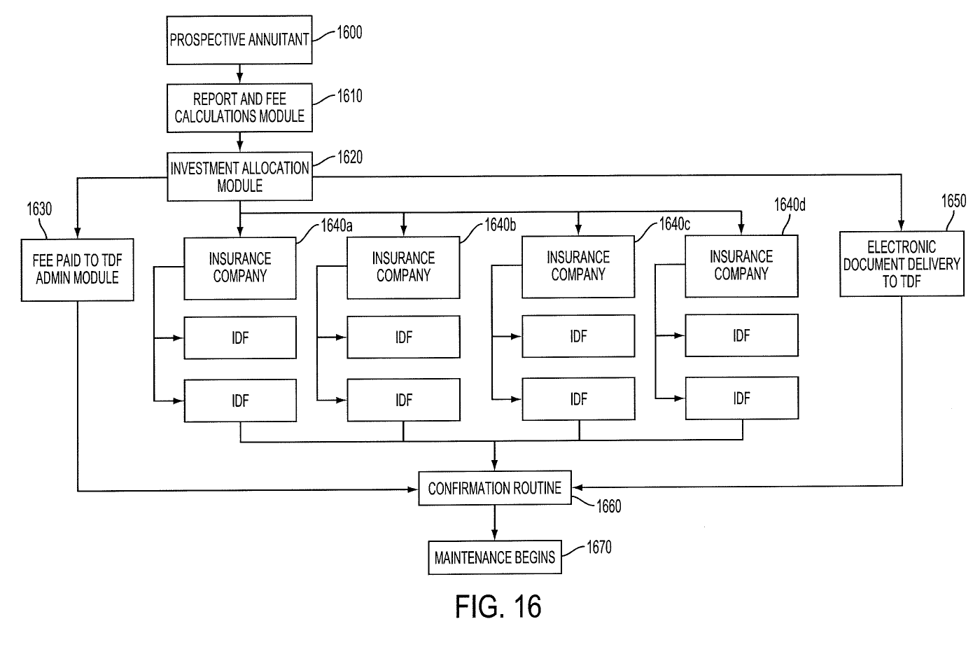

FIG. 16 is a simplified block diagram of the computer implemented system for the deliverance of documents electronically to the appropriate parties. The invention allows for significant streamlining of the subscription documents when compared with the applications for privately placed variable annuities. It further reduces by thousands of pages the amount of documents that would typically provided to prospective annuitants. Moving from the prospective annuitant 1600 is System Module 1610 which makes the necessary calculation the prospective annuitant needs to execute an investment. Element 1620 of FIG. 16 indicates that subscription agreements are delivered to and collected from prospective annuitants through the computer system. Following element 1620 of FIG. 16 is element 1640a-d of FIG. 16 indicating that subscription/investment amounts are collected from various prospective, allocated between the various insurance companies with respect to various annuity contracts and IDFs and the TDF of the TDF 1630, where fees and expenses have already been calculated with the employed computer system and then deducted and paid over to the TDF Manager and third-party vendors. Simultaneously, the related documents are electronically delivered to the TDF explained by FIG. 1650. The flow from element 1640a-d is to element 1660 indicating the collection of fees and monthly, quarterly, annually, and the delivery reports to the annuitants via either manually confirmation or electronically by the running of a confirmation routine. From element 1660 the flow proceeds to review of particular IDFs as shown in elements 1640a-d. Also the flow proceeds, as well to a review of new IDFs, as shown in elements 1640a-d. The flow from all of the elements goes to element 1670 which indicates the reallocation of funds into the different IDFs has been confirmed, and the maintenance phase begins. All of these steps utilize the computer system which includes memory, input hardware, display screens, communication devices, databases, internet access and processors as described in FIG. 10.

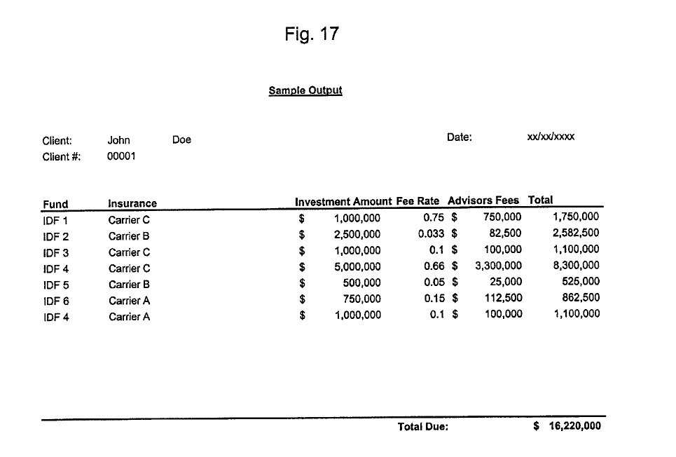

FIG. 17 is a simplified representative report of the Investment Allocation Module. Including but not limited to the related information of investor name, investor number, selected investments, related carriers and subscription amounts, as well as the calculated sums of fees, rates, investment break down and total monies due to execute the selected investments.

The foregoing describes the invention in terms of embodiments foreseen by the inventor for which an enabling description was available, notwithstanding that insubstantial modification of the invention, not presently foreseen, may nonetheless represent equivalents thereto. For the purposes of consistency, clarity and simplicity, the description is made with a particular reference to an exemplary embodiment. The present application fully contemplates any and all other disclosed and implied embodiments as would be clearly discernable to one skilled in the art. It should be noted that the pre-issuance and ongoing investment performance modeling, are particularly well-suited to be provided by means of a spread sheet program, database or other appropriate computer-based software, which would be proprietary to the embodiment of the TDF.

What is claimed is:

1. A method performed by a computer of arranging a privately placed variable annuity, comprising:
storing in a database negotiation results from negotiating with at least one life insurance company for a standardized annuity contract;
evaluating by a CPU the standardized annuity contract and a plurality of investments based upon predetermined established criteria;
maintaining a database of the results of at least one of legal analysis, regulatory analysis, due diligence, and compliance analysis with respect to the plurality of investments; effecting scalability through calculations in the CPU to provide efficiency, and effecting in the CPU a concrete embodiment as a privately placed, tax deferred fund (TDF), and storing in the database information relating to the selling by at least one broker of an interest in the TDF to a qualified prospect (Investor Annuitant) who thereby gains exposure to the privately placed variable annuity based on the standardized annuity contract and the plurality of investments.

2. The method of claim 1, wherein the TDF is created pursuant to at least one power of attorney executed by an Investor Annuitant in favor of the TDF Manager.

3. The method of claim 1, wherein the TDF is created pursuant to a limited liability company, limited partnership, series limited liability company or limited partnership, trust or series trust or any other entity treated as a disregarded entity or not subject to federal income tax under the Code.

4. The method of claim 1, wherein Investor Annuitants are aggregated to enhance risk mitigation.

5. The method of claim 1, wherein the computer is used to streamline the multi-step investment, underwriting and effectuation process of entering into variable annuity contracts.

6. The method of claim 1, wherein the prospect is able to select one or more of the plurality of eligible investments; as referred to as Insurance Dedicated Funds.

7. The method of claim 6, wherein the prospect is able to change the selection of the one or more of the plurality of Insurance Dedicated Funds during a deferral period.

8. The method of claim 7, wherein the computer is used to facilitate and track the changes in the selection of such Insurance Dedicated Funds.

9. The method of claim 1, wherein the steps of negotiation, evaluation, and performing are performed before the step of selling.

10. A method performed by a computer of arranging a life insurance contract, comprising:
storing in a database negotiation results from negotiating with at least one insurance company for a standardized life insurance contract;
evaluating by a CPU the standardized life insurance contract and a plurality of investments based upon predetermined established criteria;
maintaining a database of the results of at least one of legal analysis, regulatory analysis, due diligence, and compliance analysis with respect to the plurality of investments;
effecting scalability through calculations in the CPU to provide efficiency, and effecting in the CPU a concrete embodiment as a privately placed, tax deferred fund (TDF) and the selling by at least one broker of an interest in the TDF to a qualified prospect (Investor Owner/Insured) who thereby gains exposure to the privately placed variable life insurance contract based on the standardized life insurance contract and the plurality of investments.

11. The method of claim 10, wherein the TDF is created pursuant to at least one power of attorney executed by an Investor Owner/Insured in favor of the TDF Manager.

12. The method of claim 10, wherein the TDF is created pursuant to a limited liability company, limited partnership, series limited liability company or limited partnership, trust or series trust or any other entity treated as a disregarded entity or not subject to federal income tax under the Code.

13. The method of claim 10, wherein the prospect is able to select one or more of the plurality of eligible investments as referred to as Insurance Dedicated Funds.

14. The method of claim 13, wherein the prospect is able to change the selection of the one or more of the plurality of Insurance Dedicated Funds during the period prior to the death of the insured.

15. The method of claim 14, wherein the computer is used to facilitate and track the changes in the selection of such Insurance Dedicated Funds.

16. The method of claim 10, wherein the steps of negotiation, evaluation, and performing are performed before the step of selling.

17. The method of claim 10, wherein Investor Owners/Insurers are aggregated to enhance risk mitigation.

18. The method of claim 10, wherein the computer is used to streamline the multi-step investment, underwriting and effectuation process of entering into variable life insurance contracts.

19. The method of claim 10, wherein a Registered Entity, Dual Registered Entity or Registrant or Dual Registrant or an affiliate thereof acts as the investment manager of one or more Insurance Dedicated Funds.

20. The method of claim 10, wherein the variable annuities and variable life insurance contracts are publically offered, and the related Insurance Dedicated Funds are mutual funds under the Investment Company Act of 1940, as amended.

21. A method performed by a computer of preparing the documentation of the offering of at least one TDF and one related IDF in respect of which a TDF Manager may act as an administrative manager of the IDF, comprising:
maintaining a database of the results of at least one of legal analysis, regulatory analysis, due diligence, and compliance analysis with respect to an IDF investment manager;
effecting scalability through calculations in a CPU to provide efficiency of the documentation preparations and wherein a TDF offering memorandum will be constituted as a master offering memorandum with a supplement with respect to any material variable information related to a particular IDF, the IDF offering memorandum will be constituted as a master offering memorandum with a supplement with respect to any material variable information related to the IDF and wherein such supplements may be the same or substantially the same.
